(19) United States
(12) Patent Application Publication
(10) Pub. No.: US 2010/0183180 A1
(43) Pub. Date: Jul. 22, 2010

(54) Speaker Apparatus

(76) Inventor: Jen-Hui Tsai, Taipei City (TW)

Correspondence Address: SHOEMAKER AND MATTARE, LTD, 10 POST OFFICE ROAD - SUITE 100, SILVER SPRING, MD, 20910, US

(21) Appl. No.: 12/507,393

(22) Filed: Jul. 22, 2009

(30) Foreign Application Priority Data
Jan. 19, 2009 (TW) 098200940

(51) Int. Cl. H04R 1/20

(52) U.S. Cl. 381/338; 381/345

(57) ABSTRACT

A speaker apparatus is provide, which includes a casing, a speaker disposed in the casing, and a one-way inlet valve and a one-way outlet valve disposed in the casing for introducing and discharging air so as to balance pressure inside the casing, thereby enabling an air cushion generated by the speaker to timely dissipate without interfering with air cushions subsequently generated to thus be more capable of reproducing sound with high fidelity.

### BACKGROUND OF THE INVENTION

1. Field of the Invention

The present invention relates to speaker apparatus, and more particularly, to a speaker apparatus having a speaker disposed in a casing.

2. Description of Related Art

The speaker apparatus is an important part of an audio system. A well-designed speaker apparatus can reproduce sound with high fidelity, and resonance thereof provides rich layers of sound and various representations of timbre.

Sound frequencies are commonly divided into low, middle and high frequencies. The middle and high frequencies are emitted from the front of the speaker and the low frequency is emitted through a passageway at the rear of the speaker. Therefore, the sound quality of the low frequency sounds depends on the design of the passageway.

FIG. 1 is a sectional view of a conventional speaker apparatus. As shown in FIG. 1, the inner space of a casing 10 forms an air chamber 11, a speaker 12 is disposed in the front of the casing 10, and an air hole 110 is formed in the front of the casing 10. Therein, the air chamber 11 functions as the passageway for low frequency sounds. The low frequency sounds emitted from the rear of the speaker 12 are reflected by the walls of the air chamber 11 and transmitted out through the air hole 110. While generating the low frequency sounds, the speaker 12 generates an air cushion, which is discharged through the air hole 110 to reduce interference with air cushions generated subsequently.

However, in order to generate sounds at different frequencies, the rear of the speaker 12 needs to have different pressures so as to enable the speaker 12 to generate sound frequencies of high fidelity in each frequency range of the frequency response. When the speaker 12 generates a sound at a low frequency, the air cushion needs to have a corresponding pressure. However, since the air hole 110 has a fixed size, it is difficult to make air cushions of different pressures quickly dissipate. Therefore, the next air cushion may be generated prior to the dissipation of the previous air cushion, thereby resulting in air cushion interference and adversely affecting the sound quality.

### SUMMARY OF THE INVENTION

According to the above drawback, the present invention provides a speaker apparatus that is capable of instantly discharging an air cushion generated by the speaker so as to prevent interference of the air cushion with air cushions generated subsequently, and therefore is capable of reproducing sound with high fidelity.

The speaker apparatus comprises: a casing; a speaker disposed in the casing; and at least a one-way valve disposed in the casing for discharging or introducing air so as to balance pressure inside the casing.

The above-described speaker apparatus has at least an air chamber. Further, at least a partition board can be disposed inside the casing so as to divide an inner space of the casing into a plurality of air chambers, and at least a first air hole is formed in the partition board such that the air chambers are communicated with each other through the first air hole. In addition, at least a second air hole is formed in the casing for communicating with the air chambers.

The casing has a cylindrical shape or a barrel shape. The speaker is disposed at one end of the casing.

The one-way valve is disposed at a position located on the side of the casing. Alternatively, the one-way valve is disposed at the speaker-free end of the casing.

Therefore, the speaker apparatus of the present invention comprises at least a one-way inlet/outlet valve disposed to the casing thereof. The one-way valve can be disposed in any speaker apparatus on the market. Regardless of the number of the air chambers, when the speaker generates low frequency sound which leads to a change of pressure inside the casing, the one-way inlet valve or the one-way outlet valve introduces air into the casing or discharges air to the outside so as to balance pressure inside the casing. As a result, an air cushion generated by the speaker can timely dissipate without interfering with air cushions generated subsequently, and, accordingly, the speaker apparatus is capable of reproducing sound with high fidelity.

### BRIEF DESCRIPTION OF DRAWINGS

FIG. 1 is a cross-sectional view of a conventional speaker apparatus;

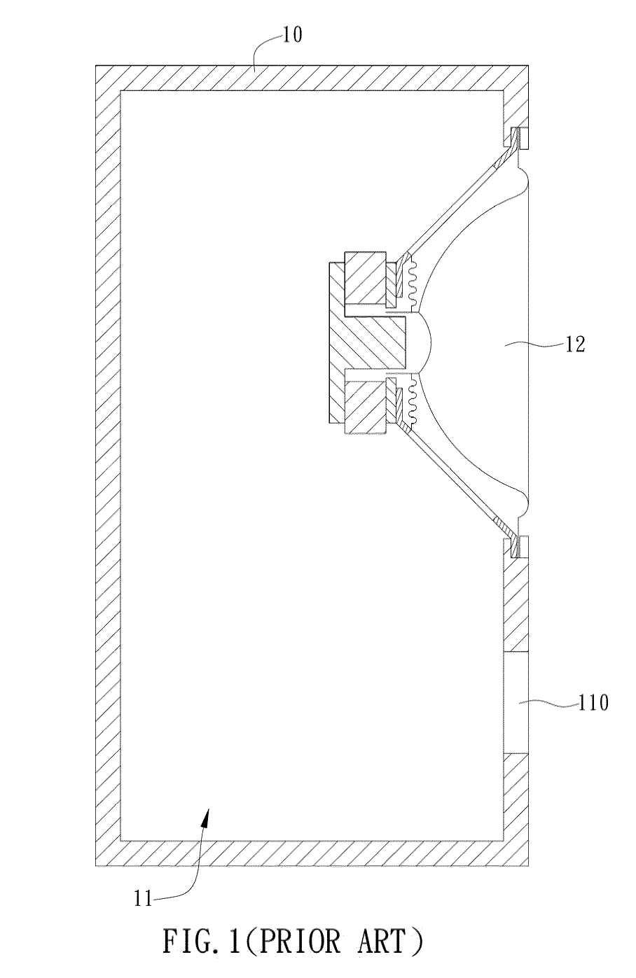

FIG. 2 is a cross-sectional view of a speaker apparatus according to the present invention;

FIG. 3A is a cross-sectional view of the speaker apparatus with a one-way outlet valve thereof staying in an open state for discharging air;

FIG. 3B is a cross-sectional view of the speaker apparatus with a one-way inlet valve staying in an open state for introducing air; and

FIG. 4 is a cross-sectional view of a speaker apparatus according to another embodiment of the present invention.

### DETAILED DESCRIPTION OF PREFERRED EMBODIMENTS

The following illustrative embodiments are provided to illustrate the disclosure of the present invention. These and other advantages and effects will be apparent to those skilled in the art after reading the disclosure of this specification.

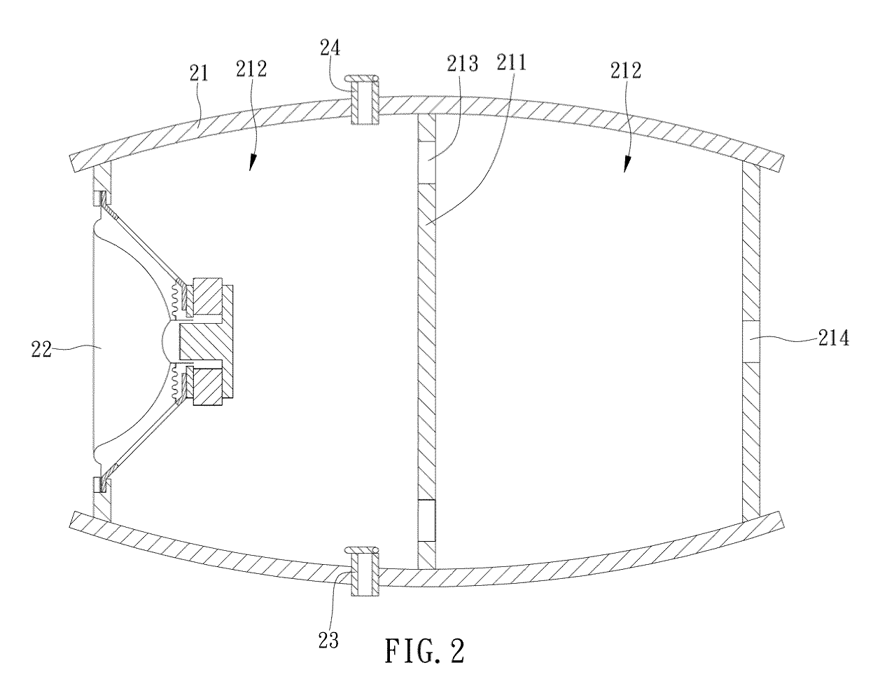

FIG. 2 shows a speaker apparatus according to the present invention. As shown in the drawing, the speaker apparatus comprises a casing 21, a speaker 22, a one-way inlet valve 23 and a one-way outlet valve 24.

The casing 21 has a cylindrical shape or a barrel shape. The casing 21 can be an oak barrel or a barrel-shaped body. At least a partition board 211 is disposed inside the casing 21 so as to divide the inner space of the casing 21 into a plurality of air chambers 212. Further, at least a first air hole 213 is formed in the partition board 211 such that the air chambers 212 are communicated with each other through the first air hole 213. At least a second air hole 214 is formed in the casing 21 for communicating with the air chambers 212.

The speaker 22 is disposed at one end of the casing 21. The one-way inlet valve 23 is disposed on a side of the casing 21 and communicated with the air chambers 212 for introducing air into the air chambers 212, thereby balancing pressure inside the casing 21. The one-way outlet valve 24 is disposed on the side of the casing 21 and communicated with the air chambers 212 for discharging air so as to balance pressure inside the casing 21. Notably, the one-way inlet valve 23 and the one-way outlet valve 24 are disposed on the side of the casing 21.

When the speaker 22 generates high frequency sound or middle frequency sound, the speaker 22 has low vibration amplitude and the pressure inside the casing 21 changes relatively little. Further, the high frequency sound or middle frequency sound is emitted from the front of the speaker 22 and therefore the one-way inlet valve 23 and the one-way outlet valve 24 remain in a closed state. When the speaker 22 generates low frequency sound at low power, an instantaneous change, if any, in the pressure inside the casing 21 is insignificant, an air cushion generated by the speaker 22 diffuses from the nearest of the air chambers 212 to the farthest through the first air hole 213 and finally discharges through the second air hole 214 of the casing 21, thereby efficiently preventing interference of the air cushion with air cushions generated subsequently and improving the sound quality.

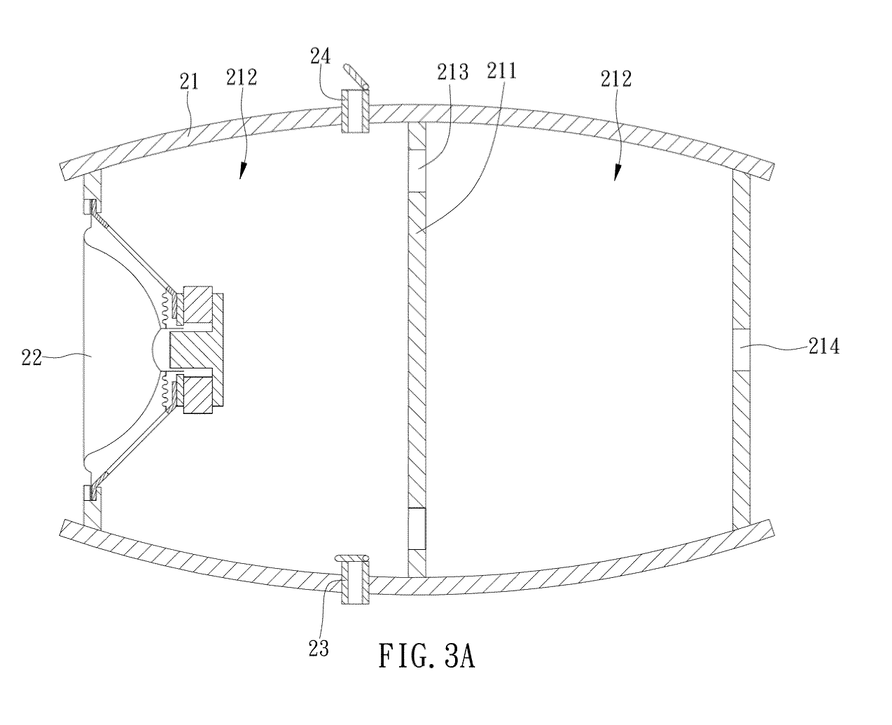

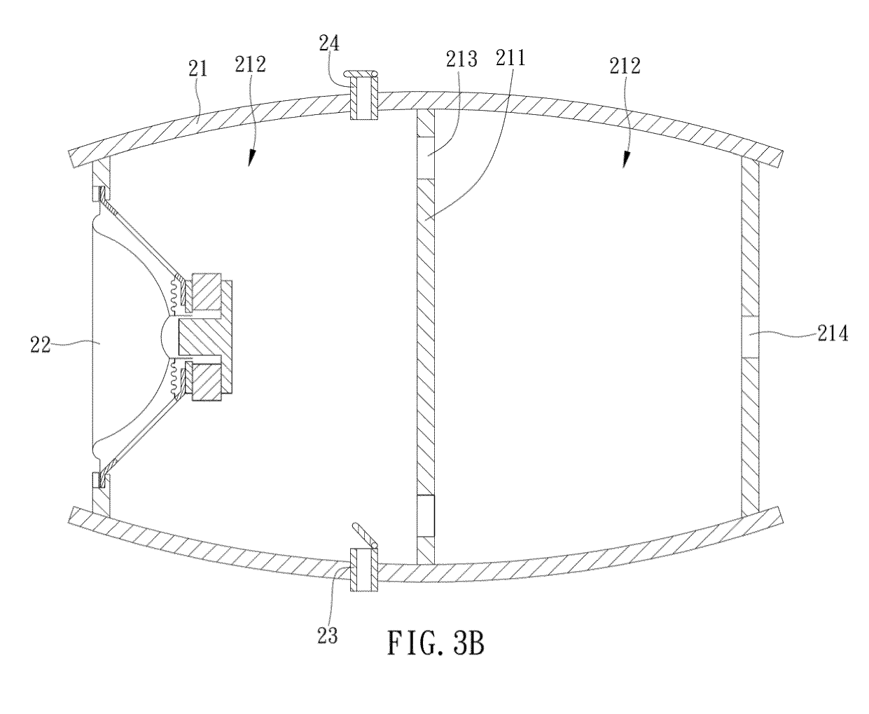

Referring to FIGS. 3A and 3B, if the speaker 22 generates low frequency sound at high power, the instantaneous change in the pressure inside the casing 21 increases, and, at the same time, the air cushion generated by the speaker 22 cannot be discharged timely through the air chambers 212 and the first and second air holes 213, 214. Accordingly, the one-way inlet valve 23 and the one-way outlet valve 24 are pushed by the air cushion so as to introduce external air into the chambers formed in casing 21 or discharge air inside the chambers of the casing 21 to the outside, thereby balancing the pressure inside the casing 21 and preventing the air cushion from interfering with the air cushions generated subsequently. As a result, the speaker apparatus is capable of reproducing sound with high fidelity.

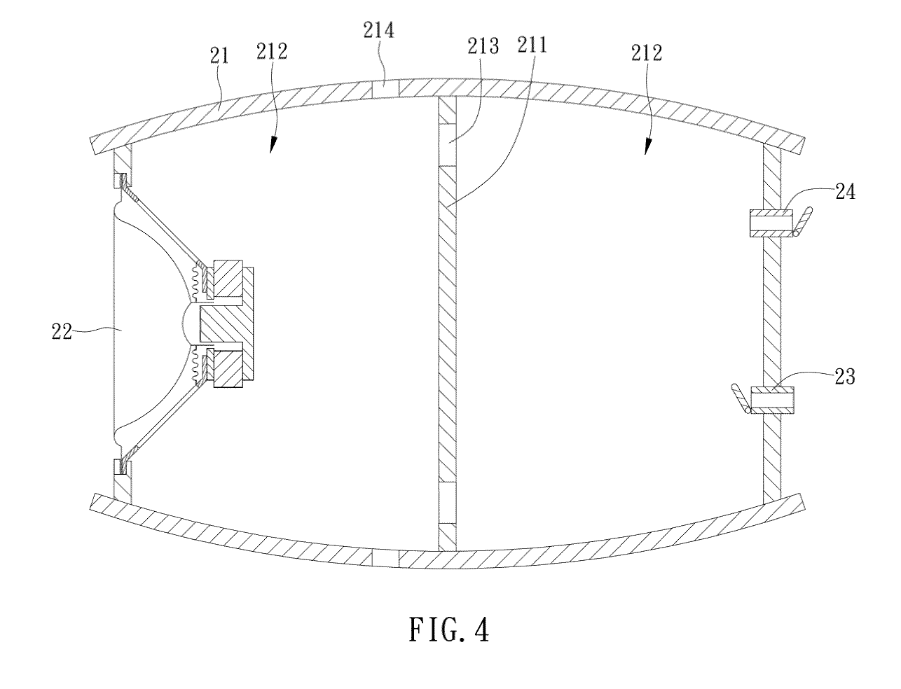

FIG. 4 shows a speaker apparatus according to another embodiment of the present invention. As shown in FIG. 4, the second air hole 214 is disposed at a position on the side of the casing 21, and the one-way inlet valve 23 and the one-way outlet valve 24 are disposed on one end of the casing 21, wherein the speaker 22 is not disposed at the one end of the casing 21. In the present embodiment, the air cushion is discharged instantly through the second air hole 214 and further discharged through the one-way inlet valve 23 or the one-way outlet valve 24. As a result, the air cushion does not interfere with the air cushions generated subsequently, and the speaker apparatus is capable of reproducing sound with high fidelity.

Therefore, the speaker apparatus of the present invention comprises the one-way inlet valve and the one-way outlet valve disposed at positions in the casing thereof such that when the speaker instantly generates low frequency sound that leads to a change of the pressure inside the casing, the one-way inlet valve introduces air into the casing or the one-way outlet valve discharges air to the outside so as to balance the pressure inside the casing. As a result, air cushions generated by the speaker can timely dissipate without interfering with the air cushions generated subsequently, and, accordingly, the speaker apparatus is capable of reproducing sound with high fidelity.

The one-way inlet valve and one-way outlet valve can be disposed in any speaker apparatus on the market or disposed to any body that has the same physical characteristics as the speaker apparatus, such as an oak barrel. Meanwhile, the above-described effect can be achieved through the one-way inlet valve and one-way outlet valve regardless of the number of the air chambers.

The above-described descriptions of the detailed embodiments are to illustrate the preferred implementation according to the present invention, and are not intended to limit the scope of the present invention. Accordingly, various modifications and variations completed by those with ordinary skill in the art will fall within the scope of present invention defined by the appended claims.

1. A speaker apparatus, comprising:
a casing;
a speaker disposed in the casing; and
at least a one-way valve disposed in the casing for discharging or introducing air so as to balance pressure inside the casing.

2. The speaker apparatus of claim 1, wherein at least a partition board is disposed inside the casing to divide an inner space of the casing into a plurality of air chambers, and at least a first air hole is formed in the partition board such that the air chambers are communicated with each other through the first air hole.

3. The speaker apparatus of claim 2, wherein at least a second air hole is formed in the casing for communicating with the air chambers.

4. The speaker apparatus of claim 1, wherein the casing has a cylindrical shape or a barrel shape.

5. The speaker apparatus of claim 1, wherein the casing is an oak barrel or a barrel-shaped body.

6. The speaker apparatus of claim 4, wherein the speaker is disposed at one end of the casing.

7. The speaker apparatus of claim 4, wherein the one-way valve is disposed at a position on a side of the casing.

8. The speaker apparatus of claim 4, wherein the one-way valve is disposed at a speaker-free end of the casing.

9. The speaker apparatus of claim 3, wherein the second air hole is disposed at a position on a side of the casing and the one-way valve is disposed at a speaker-free end of the casing.
